(19) United States
(12) Patent Application Publication
(10) Pub. No.: US 2020/0174644 A1
(43) Pub. Date: Jun. 4, 2020

(54) TOUCH SENSING DEVICE AND ANNOTATION GRAPHICAL USER INTERFACE

(71) Applicant: FlatFrog Laboratories AB, Lund (SE)

(72) Inventors: Gunnar Weibull, Malmö (SE); Joakim Hembrink, Lund (SE)

(21) Appl. No.: 16/702,271

(22) Filed: Dec. 3, 2019

Related U.S. Application Data
(60) Provisional application No. 62/775,270, filed on Dec. 4, 2018.

(51) Int. Cl. G06F 3/0481; G06F 3/0488; G06F 3/041; G06T 13/80

(52) U.S. Cl. CPC G06F 3/04812; G06F 3/0488; G06F 3/0414; G06T 2219/004; G06T 13/80; G06F 2203/04104; G06F 3/0412

(57) ABSTRACT

Systems, apparatuses, and methods are provided for improved annotation graphical user interfaces. A graphical user interface system includes logic to remove annotations after a timeout period. While a user computing device is operating in an annotation mode, when user input is received that corresponds to a pointer, an annotation visualization can be presented in the graphical user interface. Presentation of the annotation visualization changes over time, such as by being animated. Once an event is received that indicates the pointer is released, a timer is initiated. If the timer expires, then the annotation visualization is removed, such as by fading out. However, if additional user input is received within the timer period, the timer can be reset and additional annotation visualizations can be presented. Once a final timer has expired, one or more annotation visualizations can be removed. Differences in the presentation of annotation visualizations distinguishes, to viewers, additions of annotations from removals of those annotations.

### INCORPORATION BY REFERENCE TO ANY PRIORITY APPLICATIONS

This application claims benefit of U.S. Provisional Patent Application Ser. No. 62/775,270 entitled “Touch Sensing Device and Annotation Graphical User Interface” filed Dec. 4, 2018, which is hereby incorporated by reference in its entirety.

Any and all applications for which a foreign or domestic priority claim is identified in the Application Data Sheet as filed with the present application are hereby incorporated by reference under 37 CFR 1.57.

### BACKGROUND

In the context of computing devices, such as touch sensing devices, some graphical user interfaces allow a user to add graphical annotations. For example, some graphical user interface applications have “pen” or “highlighter” functions that allow a user to add visual markups. The annotations, such as the “pen” or “highlighter” annotations, have permanence in that a user must manually remove the annotations to restore the graphical user interface to a previous state. For example, after making an annotation, a user may have to access an “eraser” or an “undo” element to manually remove the previous annotations.

### SUMMARY

The systems, methods, and devices described herein each have several aspects, no single one of which is solely responsible for its desirable attributes. Without limiting the scope of this disclosure, several non-limiting features will now be discussed briefly.

According to an embodiment, a system is disclosed comprising: a media sharing server comprising one or more first hardware processors configured to execute first computer-readable instructions to: receive media from a media sharing computing device; and cause presentation, on a user computing device, of the media as a media presentation; and a pointer event server comprising one or more second hardware processors configured to execute second computer-readable instructions to: receive, from a multi-touch sensing computing device, a first set of touch user inputs for a first pointer; cause presentation, on the media presentation of the user computing device, of a first annotation visualization corresponding to the first set of touch user inputs; receive, from the multi-touch sensing computing device, a first event that indicates that the first pointer is released; initiate a first fadeout timer based at least in part on the first event that indicates that the first pointer is released; before the first fadeout timer expires, receive, from the multi-touch sensing computing device, a second set of touch user inputs for a second pointer; cause presentation, on the media presentation of the user computing device, of a second annotation visualization corresponding to the second set of touch user inputs; receive, from the multi-touch sensing computing device, a second event that the second pointer is released; initiate a second fadeout timer that replaces the first fadeout timer, wherein initiation of the second fadeout timer is based at least in part on the second event that indicates that the second pointer is released; determine that the second fadeout timer expired; and cause presentation, on the media presentation of the user computing device, of a nearly simultaneous fadeout of the first annotation visualization and the second annotation visualization.

According to an aspect, the media sharing computing device and the multi-touch sensing computing device can be the same device.

According to another aspect, the user computing device and the multi-touch sensing computing device can be the same device.

According to yet another aspect, the media sharing server and the media sharing computing device can be the same device.

According to yet another aspect, the one or more second hardware processors can be further configured to: receive, from the multi-touch sensing computing device, a third set of touch user inputs; and cause presentation, on the media presentation of the user computing device, of a third annotation visualization corresponding to the third set of touch user inputs.

According to yet another aspect, the one or more second hardware processors can be further configured to: determine, from the third set of touch user inputs, a subset of touch user inputs that occur within a threshold period of time and within a threshold area; determine, using an exponential equation, a fadeout time period based at least in part on the subset of touch user inputs; and cause presentation, on the media presentation of the user computing device, of a fadeout of the third annotation visualization according to the fadeout time period.

According to yet another aspect, the one or more second hardware processors can be further configured to: identify that the third set of touch user inputs are located within a persistence area; and mark the third annotation visualization as a persistent visualization.

According to yet another aspect, the one or more second hardware processors can be further configured to: store, in a non-transitory computer storage medium, a plurality of pointer events, wherein each pointer event from the plurality of pointer events corresponds to a touch user input from the first set of touch user inputs, and wherein each pointer event from the plurality of pointer events comprises a timestamp; receive, from a second user computing device, a playback request; and cause presentation, on a second media presentation of the second user computing device, of a fourth annotation visualization according to each timestamp and pointer event from the plurality of pointer events.

According to yet another aspect, the first annotation visualization can include a first animation.

According to yet another aspect, wherein to cause presentation of the first annotation visualization may comprise presentation of a first animation.

According to yet another aspect, wherein presentation of a first frame of the first animation may comprise a first point and a second point, wherein presentation of the first point can be thicker than presentation of the second point.

According to yet another aspect, wherein presentation of a first frame of the first animation may comprise a first point and a second point, wherein presentation of the first point can be thicker than presentation of the second point, and wherein the first point may comprise a first contrast and the second point may comprise a second contrast.

According to yet another aspect, wherein the first fadeout of the first annotation visualization can begin at a starting point of the first animation and can end at an ending point of the first animation.

According to yet another aspect, the first fadeout of the first annotation visualization can occur without a direct user command for the first fadeout.

According to an embodiment, a system is disclosed comprising: a non-transitory computer storage medium configured to at least store computer-readable instructions; and one or more hardware processors in communication with the non-transitory computer storage medium, the one or more hardware processors configured to execute the computer-readable instructions to at least: receive a first set of user inputs for a first pointer; cause presentation, on a user computing device, of media as a media presentation; cause presentation, on the media presentation of the user computing device, of a first annotation visualization corresponding to the first set of user inputs; receive a first event that indicates that the first pointer is released; initiate a first fadeout timer based at least in part on the first event that indicates that the first pointer is released; before the first fadeout timer expires, receive a second set of user inputs for a second pointer; cause presentation, on the media presentation of the user computing device, of a second annotation visualization corresponding to the second set of user inputs; receive a second event that the second pointer is released; initiate a second fadeout timer that replaces the first fadeout timer, wherein initiation of the second fadeout timer is based at least in part on the second event that indicates that the second pointer is released; determine that the second fadeout timer expired; and cause presentation, on the media presentation of the user computing device, of a first fadeout of the first annotation visualization and a second fadeout of the second annotation visualization.

According to an aspect, the one or more hardware processors can be further configured to: receive a third set of user inputs; and cause presentation, on the media presentation of the user computing device, of a third annotation visualization corresponding to the third set of user inputs.

According to another aspect, the one or more hardware processors can be further configured to: determine, from the third set of user inputs, a subset of user inputs that occur within a threshold period of time and within a threshold area; determine, using an exponential equation, a fadeout time period based at least in part on the subset of user inputs; and cause presentation, on the media presentation of the user computing device, of a fadeout of the third annotation visualization according to the fadeout time period.

According to yet another aspect, the one or more hardware processors can be further configured to: identify that the third set of user inputs are located within a persistence area; and mark the third annotation visualization as a persistent visualization.

According to yet another aspect, the user computing device can include an interactive touch monitor.

According to yet another aspect, the one or more hardware processors can be further configured to: store, in a second non-transitory computer storage medium, a plurality of pointer events, wherein each pointer event from the plurality of pointer events corresponds to a user input from the first set of user inputs, and wherein each pointer event from the plurality of pointer events comprises a timestamp; receive, from a second user computing device, a playback request; and cause presentation, on a second media presentation of the second user computing device, of a fourth annotation visualization according to each timestamp and pointer event from the plurality of pointer events.

According to yet another aspect, wherein to cause presentation of the first annotation visualization may comprise presentation of a first animation.

According to yet another aspect, wherein presentation of a first frame of the first animation may comprise a first point and a second point, wherein presentation of the first point can be thicker than presentation of the second point, and wherein the first point may comprise a first contrast and the second point may comprise a second contrast.

According to yet another aspect, wherein the fadeout of the first annotation visualization can begin at a starting point of the first animation and can end at an ending point of the first animation.

According to yet another aspect, wherein the first set of user inputs can correspond to touch user inputs or mouse user inputs.

According to yet another aspect, the one or more hardware processors can be further configured to: receive a third set of user inputs; cause presentation, on the media presentation of the user computing device, of a third annotation visualization corresponding to the third set of touch user inputs; identify that the third set of user inputs are located within a persistence area; and mark the third annotation visualization as a persistent visualization.

According to yet another aspect, the first fadeout of the first annotation visualization can occur without a direct user command for the first fadeout.

In various embodiments, systems or computer systems are disclosed that comprise a computer readable storage medium having program instructions embodied therewith, and one or more processors configured to execute the program instructions to cause the one or more processors to perform operations comprising one or more aspects of the above- or below-described embodiments (including one or more aspects of the appended claims).

In various embodiments, methods are disclosed in which one or more aspects of the above- or below-described embodiments (including one or more aspects of the appended claims) are implemented or performed. The methods can be implemented by one or more processors executing program instructions.

In various embodiments, computer program products comprising a computer readable storage medium are disclosed, wherein the computer readable storage medium has program instructions embodied therewith, the program instructions executable by one or more processors to cause the one or more processors to perform operations comprising one or more aspects of the above- or below-described embodiments (including one or more aspects of the appended claims).

### BRIEF DESCRIPTION OF THE DRAWINGS

FIG. 1A illustrates a user computing device and an annotation graphical user interface, according to some embodiments of the present disclosure.

FIG. 1B illustrates another user computing device and a shared graphical user interface, according to some embodiments of the present disclosure.

FIG. 2 illustrates a graphical user interface system, according to some embodiments of the present disclosure.

FIGS. 3A, 3B, 3C, 3D, 3E, 3F, 3G, 3H, 3I, 3J, and 3K illustrate additional annotation graphical user interfaces, according to some embodiments of the present disclosure.

FIG. 4 is a flowchart of an example method of annotation presentation, according to some embodiments of the present disclosure.

FIG. 5 illustrates another user computing device and a graphical user interface with annotation persistence features, according to some embodiments of the present disclosure.

FIGS. 6A-6B illustrates an example touch sensitive apparatus, according to some embodiments of the present disclosure.

FIG. 7 illustrates a 3D plot of an attenuation pattern generated based on energy signals from an example touch sensitive apparatus.

FIG. 8 illustrates an example computing system with which some embodiments of the present disclosure may be implemented.

### DETAILED DESCRIPTION

Although certain preferred embodiments and examples are disclosed below, inventive subject matter extends beyond the specifically disclosed embodiments to other alternative embodiments or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein. Throughout the description, the same reference numerals are used to identify corresponding elements.

As described above, existing graphical user interfaces can allow a user to add graphical annotations. For example, a user can mark up a graphical user interface with annotations, such as a presenter marking up a presentation document or display. After an annotation has been added, subsequent user interactions are required by the user to remove the previous annotations. Such subsequent user interactions can be slow, cumbersome, or can detract from the user or presentation experience.

Disclosed herein are systems, apparatuses, and methods that may be used to advantageously improve graphical user interface annotations. Instead of requiring specific user interactions to remove graphical user interface annotations, a graphical user interface system can include logic to remove the annotations after a timeout period. While a user computing device is operating in an annotation mode, when user input is received that corresponds to a pointer (such as from a finger, pen, or mouse), an annotation visualization (such as a stroke) can be presented in the graphical user interface. There can be additional logic that causes the annotation visualization to be presented differently over time. For example, the annotation visualization (such as the stroke) can have an end that is presented with a first contrast or a first thickness that is different from another portion of the annotation visualization, or the presentation of the annotation visualization can get progressively thicker or can have a second contrast until a final thickness or contrast is achieved. Once an event is received that indicates that the pointer is released, a timer can be initiated. If the timer expires, then the annotation visualization can be removed, such as by fading out. However, if additional user input is received within the timer period, the timer can be reset and additional annotation visualizations can be presented. Once a timer has expired, one or more annotation visualizations can be removed. The presentation of the annotation visualizations and the removal of the annotation visualizations can be animated. The animations of the annotation visualizations can be configured for presentation in a manner that distinguishes, to viewers, additions of annotations from removals of those annotations, which can be especially useful during media sharing where viewers can be remote from the presenter.

In order to facilitate an understanding of the systems, apparatuses, and methods discussed herein, term(s) are defined below. The term(s) defined below, as well as other terms used herein, should be construed broadly to include the provided definition(s) the ordinary and customary meaning of the term(s), or any other implied meaning for the respective term(s). Thus, the definition(s) below do not limit the meaning of these term(s), but only provide example definitions.

Media (Presentation): Any type of content that is presented on a computing device, such as, but not limited to, any type of electronic document, a text document, a word processing document, a spreadsheet document, an application, a video, an image, or a web page. Example media or media presentation can include at least a portion of a desktop, screen, or display of a computing device such as the windows or applications within the desktop, screen, or display of the computing device.

The systems, apparatuses, and methods that may be used to advantageously improve graphical user interface annotations can be applied to a media sharing context. For example, media on a first computing device can be shared or presented on one or more second computing devices. While the media from the first computing device is being shared, an annotation graphical user interface on the first computing device can be used on the shared media. Thus, annotation visualizations on the first computing device can also be shared with the second computing device(s). Moreover, the techniques for removing the annotation visualizations after a timeout period described herein can also be applied and propagated to the second computing device(s).

The systems, apparatuses, and techniques described herein may improve graphical user interfaces or computer technology. Instead of graphical user interfaces with slow, cumbersome, or inefficient annotation capabilities, improved graphical user interfaces can include efficient presentation logic for annotations. The improved annotation user interfaces can allow users, such as presenters, to quickly or efficiently make annotations without having to access different menu or graphical user interface options (such as “eraser” or “undo” graphical user interface features). The systems, apparatuses, and techniques described herein can enable users to users to progress through media faster or to interact with user interfaces faster than existing systems. In the context of touch sensing devices, efficient graphical user interface features can be especially beneficial. For example, when making annotations with touch user input (such as by a finger or pen), it may be cumbersome to provide a user with additional user interface options to perform different annotation options (such as with “eraser” or “undo” user interface options). The configuration of animations of the annotation visualizations can also advantageously distinguish, to viewer(s), additions of annotations from removals of those annotations. Thus, the improved annotation features described herein can improve graphical user interfaces or touch-sensing computer technology.

The fadeout of annotation visualizations can occur without a direct user command for the fadeout. Example direct user commands can include an eraser or undo command. For example, instead of receiving an explicit “eraser” or “undo” command, the systems, apparatuses, and techniques described herein can cause a fadeout of an annotation visualization based on a fadeout timer. As described herein, a fadeout timer can count down while user input is not received. Upon expiration of the fadeout timer, the fadeout can occur. Thus, the fadeout can occur with the direct user command for the fadeout.

In a media sharing context, the graphical user interface annotation features can be implemented using distributed servers, such as separate media sharing and pointer event server(s). The distributed servers can improve performance of media sharing or the propagation of annotation visualizations by separating each of the respective media sharing or annotation processes to operate independently of one another because a bottleneck in one of media sharing or annotation reduces the likelihood that it could affect the other process. Thus, the improved annotation features described herein can improve media-sharing and annotation computer technology.

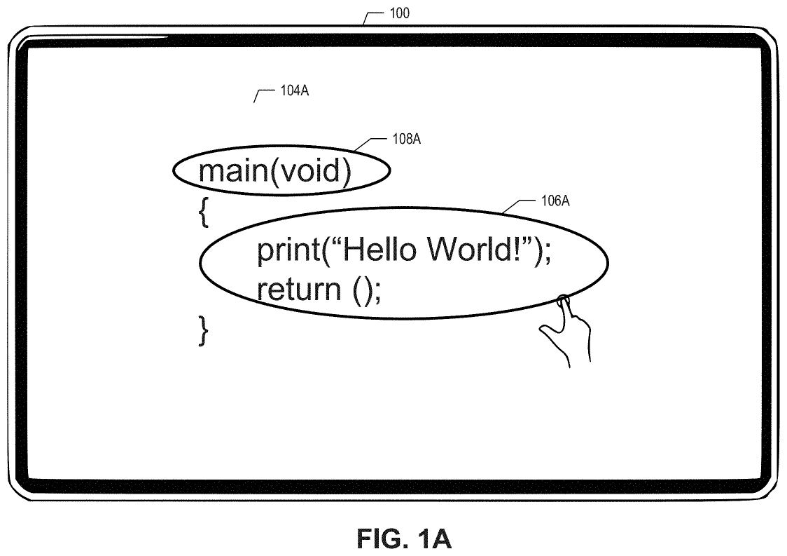

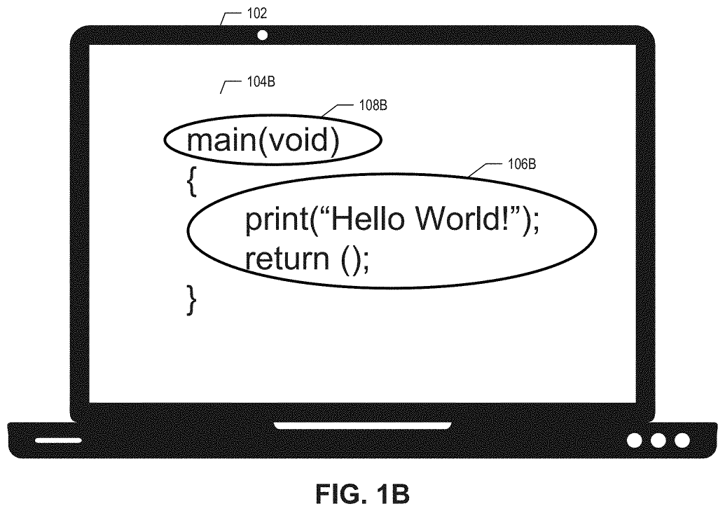

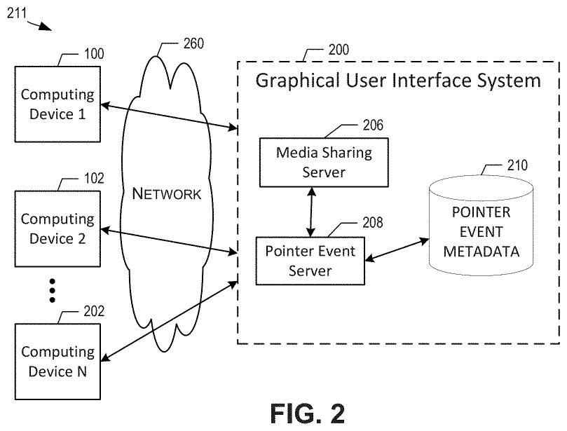

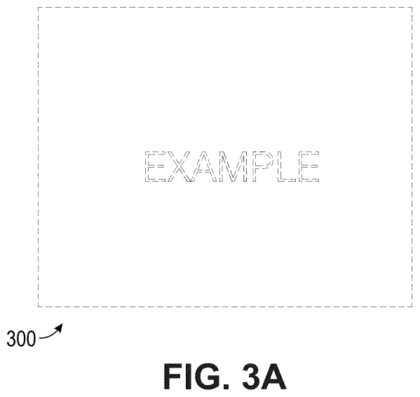

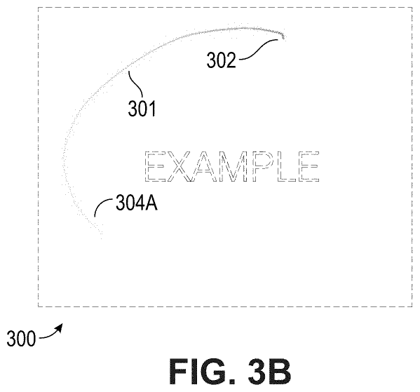

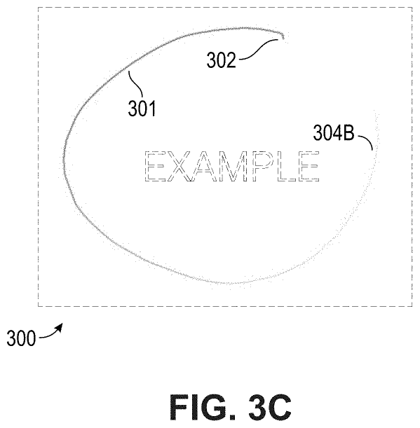

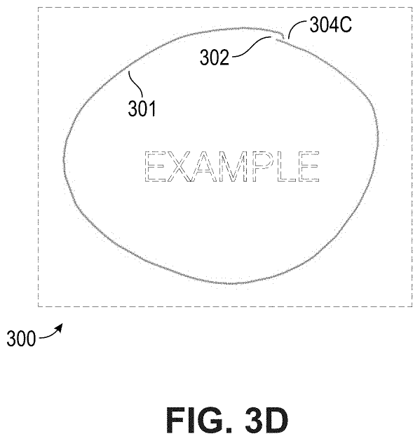

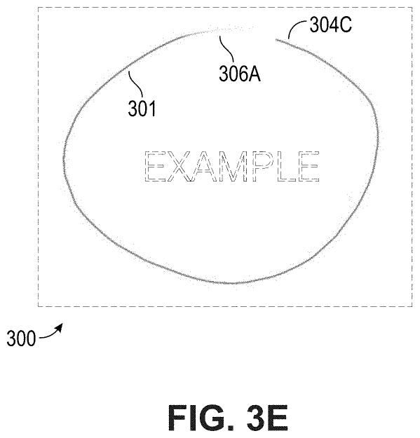

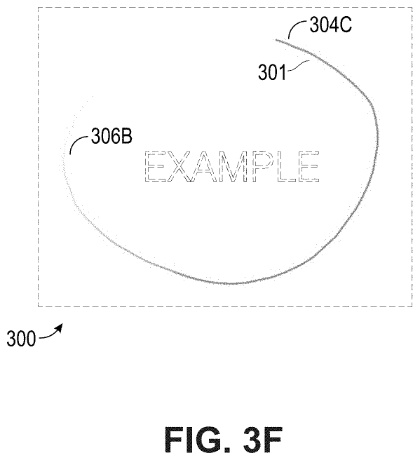

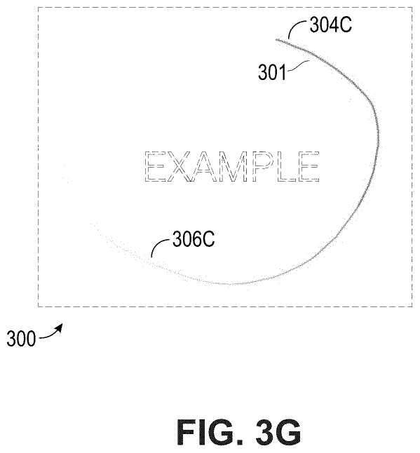

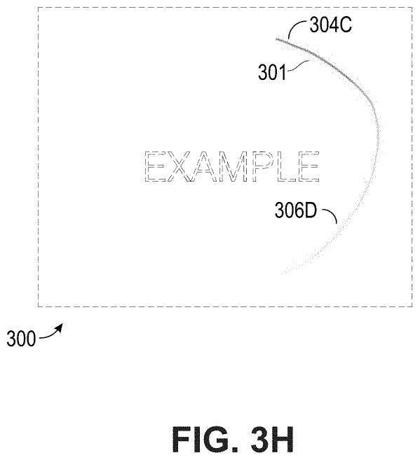

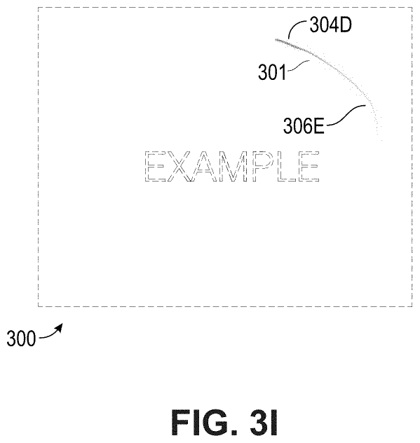

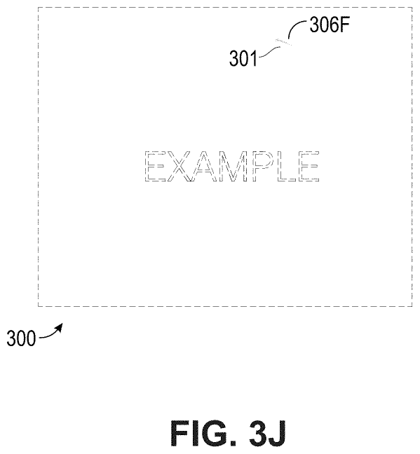

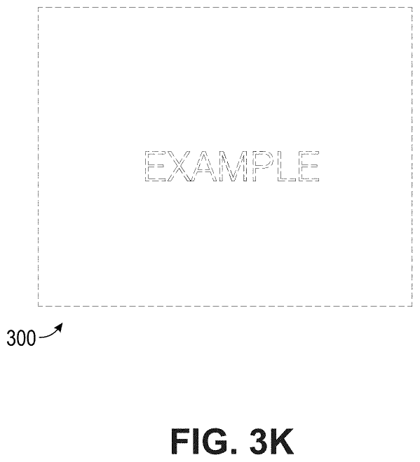

FIG. 1A depicts a user computing device 100, which can be a touch sensing device. As shown, the user computing device 100 can present media 104A. The user computing device 100 can include a graphical user interface. A user can interact with the graphical user interface of the user computing device 100 to annotate the media 104A. In particular, the user computing device 100 can receive, via the graphical user interface, user input such as touch user input. The first annotation visualization 106A can correspond to a first set of touch user inputs such as inputs received from a finger or touch pen. The second annotation visualization 108A can correspond to a second set of touch user inputs. While the annotation visualizations 106A, 108A are shown as oval shapes, example annotation visualizations can include any kind of shape. The set of touch user inputs can be transmitted to a pointer event server, which is described in further detail below with respect to FIG. 2. While not shown in FIG. 1A, the annotation visualization 106A can be removed after a timeout period, which is described below in further detail with respect to FIGS. 3A-3K. The example user computing device 100 can be, but is not limited to, a 42″, 55″, 65″, 75″, 84″, or 86″ interactive touch monitor.

FIG. 1B depicts another user computing device 102. Similar to the user computing device 100 of FIG. 1A, the user computing device 102 can present media 104B. The media 104B of FIG. 1B can correspond to the media 104A of FIG. 1A, such as by being shared from the same source or by being shared from the user computing device 100 of FIG. 1A to the user computing device 102 of FIG. 1B. A media sharing server can transmit the media 104A, 104B to the user computing device 100, 102 of FIG. 1A or 1B, which is described below in further detail with respect to FIG. 2. A pointer event server can cause the presentation of the first annotation visualization 106B and the second annotation visualization 108B of FIG. 1B, which can correspond to the first annotation visualization 106A and the second annotation visualization 108A of FIG. 1A, respectively. Moreover, while not shown, the pointer event server can further cause the first annotation visualization 106B and the second annotation visualization 108B of FIG. 1B to be removed after a timeout period, which can occur nearly simultaneously with the removal of the first annotation visualization 106A and the second annotation visualization 108A of FIG. 1A.

FIG. 2 illustrates a graphical user interface system 200, according to some embodiments of the present disclosure. In embodiments of FIG. 2, the computing environment 211 can include a network 260, the graphical user interface system 200, a first computing device 100, a second computing device 102, and one or more additional computing devices 202. Various communications between these devices are illustrated. Any of the computing devices, such as the computing device 100, can transmit media to the graphical user interface system 200, which can be shared with other computing devices, such as the second computing device 102 or the one or more additional computing devices 202. Any of the computing devices, such as the computing device 100, can send user input, such as touch user inputs that correspond to an annotation visualization, to the graphical user interface system 200. The graphical user interface system 200 can cause the presentation of corresponding annotation visualizations on the computing device(s), such as the second computing device 102 or the one or more additional computing devices 202. Any of the computing devices 100, 102, 202 can include a user computing device, such as an interactive touch monitor, multi-touch sensing computing device, desktop, laptop, tablet, cell phone, smartphone, personal digital assistant (PDA), or any other device.

The graphical user interface system 200 can include a media sharing server 206, a pointer event server 208, and a pointer event metadata storage 210. The media sharing server 206 can receive media from any of the computing devices 100, 102, 202. The media sharing server 206 can cause presentation of the media as a media presentation on the computing devices 100, 102, 202. The pointer event server 208 can receive user input from any of the computing devices 100, 102, 202. The pointer event server 208 can cause the presentation of annotation visualizations on any of the computing devices 100, 102, 202 based on the user input. In some embodiments, locally received user input can cause the presentation of an annotation visualization on the respective computing device that received the user input without needing to communicate with an external server. The annotation visualizations can be removed on the computing devices 100, 102, 202 after a timer expires without receiving additional user input. The pointer event server 208 can store some user interaction data corresponding to the user input such as event data in the pointer event metadata storage 210. The pointer event server 208 can cause the presentation of annotation visualizations based on some of the event data or other data in the pointer event metadata storage 210.

In some embodiments, presentation of annotation visualizations can occur without the pointer event server 208. For example, a computing device that receives pointer user input, such as the computing device 100, can present a corresponding annotation visualization based on the locally received user input. However, other computing devices, such as the computing devices 102, 202, can present a corresponding annotation visualization based on communication with the pointer event server 208.

While multiple computing devices 100, 102, 202 are shown in FIG. 2, the annotation features described herein can be implemented in a single computing device, such as the computing device 100, and without any media sharing. For example, while not shown, the graphical user interface system 200 can be implemented in the computing device 100. Instead of a media sharing server 206 and a pointer event server 208, a pointer event service and the pointer event metadata storage 210 can be implemented in the computing device 100 to accomplish some of the annotation features described herein.

FIGS. 3A, 3B, 3C, 3D, 3E, 3F, 3G, 3H, 3I, 3J, and 3K illustrate annotation graphical user interfaces, according to some embodiments of the present disclosure. The graphical user interfaces of FIGS. 3A, 3B, 3C, 3D, 3E, 3F, 3G, 3H, 3I, 3J, and 3K can include a media presentation. The example media presentation of FIGS. 3A, 3B, 3C, 3D, 3E, 3F, 3G, 3H, 3I, 3J, 3K includes the “Example” text. The graphical user interfaces of FIGS. 3A, 3B, 3C, 3D, 3E, 3F, 3G, 3H, 3I, 3J, and 3K can be presented on a computing device, such as the computing device 100 of FIG. 1A or 2 or any other computing device discussed herein. Each of the graphical user interfaces of FIGS. 3A, 3B, 3C, 3D, 3E, 3F, 3G, 3H, 3I, 3J, and 3K can be similar to one another in that they may represent a series of media presentations in combination with the presentation of annotation visualizations corresponding to user input or the lack thereof. The presentation of annotation visualizations in FIGS. 3A, 3B, 3C, 3D, 3E, 3F, 3G, 3H, 3I, 3J, and 3K can depict one or more animations. The graphical user interfaces of FIGS. 3A, 3B, 3C, 3D, 3E, 3F, 3G, 3H, 3I, 3J, and 3K can be similar to the graphical user interface of FIG. 1A or 1B.

In FIG. 3A, the graphical user interface 300 presents the media. The example media includes the “Example” text. In FIG. 3A, the graphical user interface 300 may not have received any user input with respect to a pointer or any annotations user input. Thus, the graphical user interface 300 may not include annotations. In FIG. 3B, the graphical user interface 300 can include an annotation visualization 301. The annotation visualization 301 can correspond to a set of user inputs (such as touch user inputs). User input for the pointer of the annotation visualization 301 can begin at a first point 302 and has a current endpoint 304A. As shown, presentation of the first point 302 can be thicker than presentation of the current endpoint 304A. The first point 302 can include a first contrast (such as a first color that can be darker than a second color) and the current endpoint 304A can include a second contrast (such as a second color that can be lighter or brighter than the first color).

In FIG. 3C, the graphical user interface 300 can include the annotation visualization 301, which can be a continuation of the annotation visualization 301 from FIG. 3B. The annotation visualization 301 in FIG. 3C can be similar to the annotation visualization 301 in FIG. 3B. The annotation visualization 301 can correspond to a set of user inputs that begins at the first point 302 and has a current endpoint 304B. In FIG. 3D, the graphical user interface 300 can include the annotation visualization 301, which can be a continuation of the annotation visualization 301 from FIG. 3C. The annotation visualization 301 in FIG. 3D can be similar to the annotation visualization 301 in FIG. 3B or 3C. The annotation visualization 301 can correspond to a set of user inputs that begins at the first point 302 and has the endpoint 304C. In FIG. 3D, it can be determined that the pointer is released, which can affect the animation of the annotation visualization 301. The first point 302 can include a first thickness and the endpoint 304C can also include the same first thickness. The first point 302 can include a first contrast and the endpoint 304C can also include the same first contrast. The annotation visualization 301 of FIGS. 3A, 3B, 3C, and 3D can depict a first animation.

In the graphical user interface 300 of FIGS. 3D, 3E, 3F, 3G, 3H, 3I, 3J, and 3K, fadeout of the first annotation visualization 301 can be depicted. In FIG. 3E, the fadeout of the annotation visualization 301 can begin at a starting point of the first animation shown in FIGS. 3A, 3B, 3C, and 3D. As shown, during a fadeout, presentation of a current fadeout point 306A can be thinner than presentation of the endpoint 304C. The first point 302 can include a second contrast (such as a second color that can be lighter or brighter than a second color) and the endpoint 304C can include a first contrast (such as a first color that can be darker than the second color).

In FIG. 3F, the graphical user interface 300 can include the annotation visualization 301, which can be a continuation of the annotation visualization 301 from FIG. 3E. The annotation visualization 301 in FIG. 3F can be similar to the annotation visualization 301 in FIG. 3E. In FIG. 3F, the fadeout of the annotation visualization 301 can progress to the current fadeout point 306B. In FIGS. 3G, 3H, 3I, and 3J the graphical user interface 300 can include the annotation visualization 301, which can be a continuation of the annotation visualization 301 from FIGS. 3E and 3F. The fadeout of the annotation visualization 301 in FIGS. 3G, 3H, 3I, and 3J can progress similarly to the fadeout shown in FIGS. 3E and 3F. In particular, the current fadeout point 306C, 306D, 306E, 306F in FIGS. 3G, 3H, 3I, and 3J, respectively, can update accordingly until the fadeout is complete in FIG. 3K. The first animation of the annotation visualization 301 shown in FIGS. 3A, 3B, 3C, and 3D can be presented differently than the fadeout animation of the annotation visualization 301 shown in FIGS. 3D, 3E, 3F, 3G, 3H, 3I, and 3K to distinguish the addition of an annotation visualization from the removal of the annotation visualization.

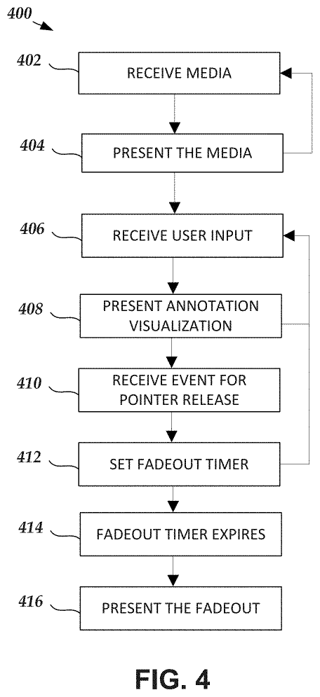

FIG. 4 is a flowchart of an example method 400 of annotation presentation, according to some embodiments of the present disclosure. Although the method 400 is described in conjunction with the system of FIG. 2, any system configured to perform the method, in any order, is within the scope of this disclosure. The method 400 may be performed by the various components of the graphical user interface system 200 of FIG. 2 as discussed herein, including the media sharing server 206 or the pointer event server 208. Depending on the embodiment, the method 400 may include fewer or additional blocks or the blocks may be performed in an order different than is illustrated.

Beginning at block 402, media can be received. For example, the media sharing server 206 can receive media from a media sharing computing device, such as the computing device 100. As described herein, the computing device 100 can be a multi-touch sensing computing device. Example media sharing can include sharing display information such as in the context of a screen mirror. Examples of media are described herein, such as with respect to FIG. 1A, 1B, or 3A-3K.

At block 404, media can be presented. For example, the media sharing server 206 can cause presentation of the media from the previous block 402. In particular, the media sharing server 206 can cause presentation of the media on a computing device such as a user computing device. As described herein, the user computing device can be a multi-touch sensing computing device. The media sharing server 206 and the media sharing computing device can be the same device. Examples of the presentation of media are described herein, such as with respect to FIG. 1A, 1B, or 3A-3K.

The blocks 402, 404 can be executed in a loop as shown. For example, as updates to the media are transmitted to the media sharing server 206, the presentation of the media on one or more computing devices can update subsequently or continuously. As described herein, the presentation of the media may be handled by the media sharing server 206, which may occur independently of the graphical user interface annotations that can be overlaid on the media presentation. Thus, while the media blocks 402, 404 are shown at the beginning of the example method 400, the media blocks 402, 404 can occur at any point in the method 400.

At block 406, user input can be received. For example, the pointer event server 208 can receive user input from the computing device 100. Example user input can include a set of touch user inputs for a pointer. Examples of user input are described herein, such as with respect to FIG. 1A, 1B, or 3A-3K. The user input data that is received can include coordinate data in a time series format. The user input or data related to the user input can be stored in the pointer event metadata storage 210. In some embodiments, the pointer event server 208 can store, in the pointer event metadata storage 210, pointer events. Each pointer event can correspond to user input from a set of user inputs (such as touch user input or mouse user input). Each pointer event can include or be stored with a corresponding timestamp. Metadata regarding associations between pointer events and particular media or media presentations can be stored in the pointer event metadata storage 210. As described herein, the storage of pointer events with timestamps can be used with the playback of media presentation or annotation visualizations.

At block 408, an annotation visualization can be presented. For example, the pointer event server 208 can cause presentation of an annotation visualization on a computing device, such as the computing device(s) 100, 102, 202. The presentation of the annotation visualization can be overlaid on the media presentation of a computing device, such as the computing device(s) 100, 102, 202. The annotation visualization can correspond to the user input (such as the set of touch user inputs) received at the previous block 406. Examples of annotation visualizations are described herein, such as with respect to FIG. 1A, 1B, or 3A-3K.

Presentation of the annotation visualization can include an animation. The animation can include a series of frames. A frame of the animation can include a first point and a second point, which can be connected by a line. Presentation of the first point can be thicker than presentation of the second point. The first point can include a first contrast and the second point can include a second contrast. Additional details regarding the animation of annotation visualizations are described herein, such as with respect to FIGS. 3A-3K.

In some embodiments, presentation of the annotation visualization can occur after the corresponding user input has been received, such as in the context of a playback of the media presentation or the annotation visualization. For example, the pointer event server 208 can cause a playback of the presentation of an annotation visualization minutes, hours, or days after the corresponding user input for the annotation was received. The pointer event server 208 can retrieve pointer events from the pointer event metadata storage 210. After a playback request is received from a computing device, the pointer event server 208 can cause presentation, on the media presentation of the computing device, of an annotation visualization according to each respective timestamp and pointer event from the pointer event metadata storage 210.

At block 410, an event can be received for a pointer release. For example, the pointer event server 208 can receive an event (such as a first event) from the computing device 100 that indicates that a pointer (such as a first pointer) is released. An example release of a pointer can be caused by a user removing their finger or a touchpad from a touch sensing device or by releasing a selection of a user input device such as a mouse. The release of the pointer can indicate that user input for an annotation has at least temporarily stopped.

At block 412, a fadeout timer can be set. For example, the pointer event server 208 can initiate a fadeout timer (such as a first fadeout timer) based at least in part on the received event that indicates that a pointer was released. An example fadeout timer can be for a period of time, such as, but not limited to, 1, 2, 3, 4, 5, or 6 seconds. The period of time can be configurable. If the fadeout timer expires, then the pointer event server 208 may cause a fadeout of the annotation visualization, which is described in further detail below. However, if additional user input is received after a loop back to block 406, then the fadeout timer may be reset.

In some embodiments, instead of block 412 (or the next blocks 414 or 416) being implemented by the pointer event server 208, one or more of these blocks can be implemented by a computing device, such as the computing device(s) 100, 102, 202. The logic for implementing delay can be on the client side. A computing device, such as the computing device(s) 100, 102, 202, can locally keep track of fadeout or delay of a fadeout with respect to an annotation visualization.

In particular, at a return to block 406 and before the first fadeout timer expires, the pointer event server 208 can receive from the computing device 100 second user input (such as a second set of touch user inputs) for a second pointer. At a return to block 408, the pointer event server 208 can cause presentation, on the media presentation, of a second annotation visualization corresponding to the second user input. At a return to block 410, the pointer event server 208 can receive a second event from the computing device 100 that indicates that a second pointer is released. As a result of the receipt of the second event, at a return to block 412, the pointer event server 208 can initiate a second fadeout timer that replaces the first fadeout timer. In some embodiments, instead of the first fadeout timer being replaced, the first fadeout timer can be reset. A fadeout timer can be reset when a new pointer event is registered. This solution can be robust since it can still work even in the case where a pointer event is missed. The fadeout of one or more annotation visualizations can be delayed so long as additional user input is received within a threshold period of time.

At block 414, it can be determined that a fadeout timer has expired. For example, the pointer event server 208 can determine that the first or second fadeout timer has expired. In particular, the pointer event server 208 can determine that a period of time has elapsed (such as 3 seconds) without the pointer event server 208 receiving additional user input to further delay removal of an annotation visualization.

In particular, the fadeout of annotation visualizations can occur without a direct user command for the fadeout. Instead of an explicit “eraser” or “undo” command, the pointer event server 208 can cause a fadeout of an annotation visualization after the fadeout timer has expired. The fadeout timer can count down while user input is not received. Upon expiration of the fadeout timer, the pointer event server 208 can cause the fadeout. The pointer event server 208 can cause the fadeout without a direct user command for the fadeout.

At block 416, the fadeout can be presented. For example, the pointer event server 208 can cause presentation, on the media presentation of a computing device, of a fadeout (or removal) of one or more annotation visualizations. In some embodiments, the pointer event server 208 can cause a near simultaneous fadeout (or removal), on the media presentation of a computing device, of the one or more annotation visualizations. For example, if first and second annotation visualizations are presented as first and second ovals, then the first and second ovals can fadeout (or be removed) at approximately the same time in the same graphical user interface. The fadeout of the annotation visualization can begin at a starting point of the animation when the annotation visualization was added and can end at an ending point of the same animation. Additional details of the fadeout are described in further detail herein such as with respect to FIGS. 3D-3K.

In some embodiments, the pointer event server 208 can keep track of active pointers. The pointer event server 208 can determine if there are one or more active pointers. The pointer event server 208 can cancel a fadeout timer (if active) when the number of active pointers stops being zero, and active the fadeout timer when the number of active pointers turns to zero.

In some embodiments, presentation of the fadeout can be based on logic with respect to specific user input. For example, where user input corresponds to a long touch event within a threshold area (such as a user holding their finger or pen down in a specific area), additional fadeout logic can be applied such that the fadeout can be accelerated with respect to the long touch event. The pointer event server 208 can determine, from a set of user inputs, a subset of touch user inputs that occur within a threshold period of time and within a threshold area (for example, any set of touch events that occur longer than one second within a one centimeter area). The subset of touch user inputs can thus indicate a long touch event. The pointer event server 208 can determine, using an equation (such as a linear or exponential equation), a fadeout time period based at least in part on the subset of touch user inputs. For example, where the pointer event server 208 uses an exponential equation such as an exponential decay function, touch input up to 1 second as input to the equation may output a corresponding fadeout time period of 500 milliseconds, but any touch input beyond 1 or 2 seconds may result in a corresponding fadeout time period of a much smaller amount such as 1 millisecond or even mere microseconds. The pointer event server 208 can cause presentation, on the media presentation of the computing device, of a fadeout of the third annotation visualization according to the fadeout time period, which can accelerate the fadeout animation for a viewer and provide a more efficient user experience by possibly eliminating long and cumbersome fadeout animations.

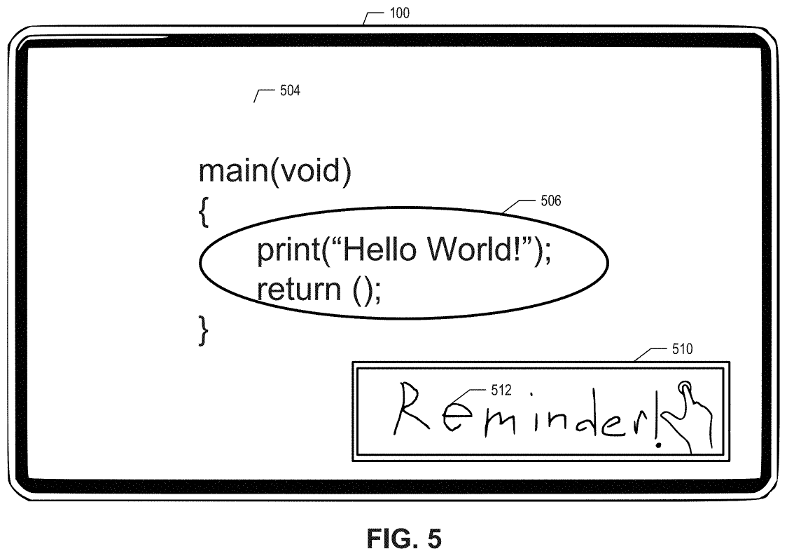

In some embodiments, at the fadeout-related blocks 412, 414, or 416, a determination can be made whether a fadeout or a fadeout timer should be applied. For example, the pointer event server 208 can determine whether a fadeout or a fadeout timer should be applied based at least on whether the annotation visualization or the corresponding user input occurred within a persistence area. Additional details regarding a persistence area are described in greater detail below with respect to FIG. 5. The pointer event server 208 can identify that a set of touch user inputs are located within a persistence area. The pointer event server 208 can then mark the corresponding annotation visualization as a persistent visualization. Once an annotation visualization has been marked as persistent, the pointer event server 208 may ignore the removal of the visualization eventer after a timer expires. Additionally or alternatively, after the pointer event server 208 determines that an annotation visualization should be persistent, the pointer event server 208 can prevent the instantiation of a corresponding fadeout timer.

Some of the blocks 402, 404, 406, 408, 410, 412, 414, 416 of the example method 400 can correspond to the annotation pseudo-algorithm(s) described in the below Tables 1, 2, or 3.

TABLE 1
When time a pointer (finger, pen or mouse) is moved:
Draw the stroke:
The end where the pointer can have one contrast (e.g., yellow) and
can be thinner. This can be the “glowing” end.
The stroke can then get progressively thicker and can have more of the
final contrast until it is a final thickness and contrast (e.g., red)
a bit into the stroke. This can be the glowing part of the stroke.
The rest of the stroke can be the final thickness and contrast.
Delay the fadeout for all of the finished strokes by a set time (e.g., 3
seconds).

TABLE 2

When a pointer is released:
The glowing part of the stroke can be made thicker until it's
the same thickness and contrast as the rest of the stroke. This
can be animated.
Set a time for the fadeout of the stroke (e.g. in 3 seconds).
The time can be delayed if any other pointer is moved.

TABLE 3
When a fadeout is due:
Similarly to when drawing the stroke, the stroke can fade out with
a glowing yellow end which gets progressively thicker and more one
contrast (e.g., red) until it's the full thickness and contrast
a bit into the stroke.
The fadeout starts at the beginning of the stroke and begins shortening
the stroke at an accelerating pace, until it reaches a set fadeout speed.

FIG. 5 depicts the user computing device 100 with a graphical user interface. As shown, the user computing device 100 can present media 504 and a first annotation visualization 506. The graphical user interface, the media 504, and the first annotation visualization 506 of FIG. 5 can be similar to the graphical user interface, the media 104A, and the annotation visualization 106 of FIG. 1A. However, in addition to the graphical user interface of FIG. 1A, the graphical user interface of FIG. 5 can include a persistence area 510. The persistence area 510 can be instantiated by a user, such as by accessing a configuration option (not shown) in the graphical user interface. Due to the default nature of annotations being removed after a threshold period of time without additional user input, the persistence area 510 can be advantageous in that annotations made within the persistence area 510 (such as the second annotation visualization 512) can remain in the graphical user interface of one or more computing devices after a fadeout timer has expired. Thus, while the first annotation visualization 506 may be removed after the fadeout timer has expired without additional user input, the second annotation visualization 512 may remain because it is within the persistence area 510. Additional, specific user input (not illustrated) may cause the removal of the annotation visualization within the persistence area 510, such as user selection of a user interface option to remove the visualization.

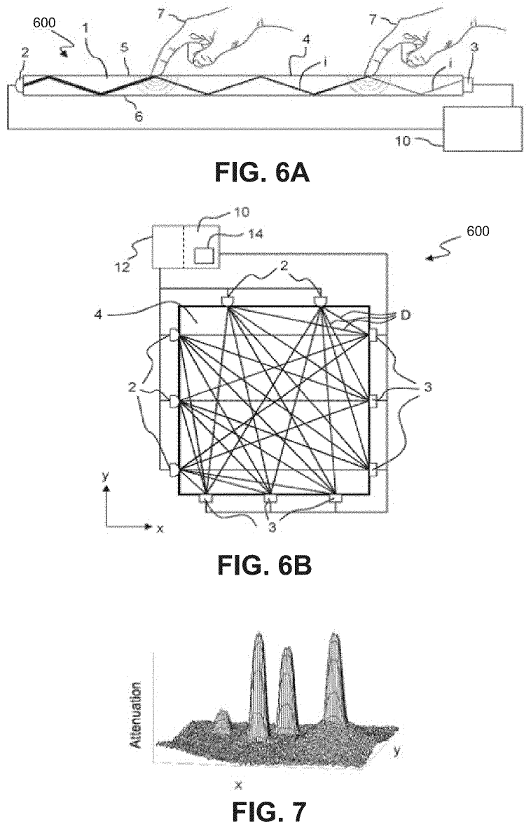

FIGS. 6A-6B illustrates an example touch sensitive apparatus 600 that is based on the concept of FTIR (Frustrated Total Internal Reflection). The touch sensitive apparatus 600 can be included in any of the computing devices discussed herein, such as the user computing device 100 of FIG. 1A. The apparatus 600 operates by transmitting light inside a panel 1 from light emitters 2 to light sensors or detectors 3, so as to illuminate a touch surface 4 from within the panel 1. The panel 1 can be made of solid material in one or more layers and may have any shape. The panel 1 can define an internal radiation propagation channel, in which light propagates by internal reflections. In the example of FIG. 6A, the propagation channel can be defined between the boundary surfaces 5, 6 of the panel 1, where the top surface 5 allows the propagating light to interact with touching objects 7 and thereby defines the touch surface 4. This can be achieved by injecting the light into the panel 1 such that the light is reflected by total internal reflection (TIR) in the touch surface 4 as it propagates through the panel 1. The light may be reflected by TIR in the bottom surface 6 or against a reflective coating thereon. It is also conceivable that the propagation channel is spaced from the bottom surface 6, e.g., if the panel comprises multiple layers of different materials. The apparatus 600 may be designed to be overlaid on or integrated into a display device or monitor (not shown).

The apparatus 600 allows an object 7 that is brought into close vicinity of, or in contact with, the touch surface 4 to interact with the propagating light at the point of touch. In this interaction, part of the light may be scattered by the object 7, part of the light may be absorbed by the object 7, and part of the light may continue to propagate in its original direction across the panel 1. Thus, the touching object 7 causes a local frustration of the total internal reflection, which leads to a decrease in the energy (or equivalently, the power or intensity) of the transmitted light, as indicated by the thinned lines “i” downstream of the touching objects 7 in FIG. 6A.

The emitters 2 can be distributed along the perimeter of the touch surface 4 to generate a corresponding number of light sheets inside the panel 1. Each light sheet can be formed as a beam of light that expands (as a “fan beam”) in the plane of the panel 1 while propagating in the panel 1 from a respective incoupling region/point on the panel 1. The detectors 3 can be distributed along the perimeter of the touch surface 4 to receive the light from the emitters 2 at a number of spaced-apart outcoupling regions/points on the panel 1. The incoupling and outcoupling regions/points can refer to the positions where the beams enter and leave, respectively, the panel 1. The light from each emitter 2 can propagate inside the panel 1 to a number of different detectors 3 on a plurality of light propagation paths D. Even if the light propagation paths D correspond to light that propagates by internal reflections inside the panel 1, the light propagation paths D may conceptually be represented as “detection lines” that extend across the touch surface 4 between pairs of emitters 2 and detectors 3, as shown in FIG. 6B. Thereby, the emitters 2 and detectors 3 collectively define a grid of detection lines D (“detection grid”) on the touch surface 4. The spacing of detection lines in the detection grid may define the spatial resolution of the apparatus 600, i.e. the smallest object that can be detected on the touch surface 4.

The detectors 3 can collectively provide an output signal, which can be received or sampled by a signal processor 10. The output signal can contain a number of sub-signals, also denoted “projection signals”, each representing the energy of light emitted by a certain light emitter 2 or received by a certain light detector 3. Depending on implementation, the signal processor 10 may need to process the output signal for separation of the individual projection signals. The projection signals can represent the received energy, intensity or power of light received by the detectors 3 on the individual detection lines D. Whenever an object touches a detection line, the received energy on this detection line is decreased or “attenuated.”

The signal processor 10 may be configured to process the projection signals so as to detemline a property of the touching objects, such as a position (e.g., in the x, y coordinate system shown in FIG. 6B), a shape, or an area. This determination may involve a straight-forward triangulation based on the attenuated detection lines or a more advanced processing to recreate a distribution of attenuation values (for simplicity, referred to as an “attenuation pattern”) across the touch surface 1, where each attenuation value represents a local degree of light attenuation. An example of such an attenuation pattern is given in the 3D plot of FIG. 7. The attenuation pattern may be further processed by the signal processor 10 or by a separate device (not shown) for determination of a position, shape or area of touching objects. The attenuation pattern may be generated, e.g., by any available algorithm for image reconstruction based on projection signal values, including tomographic reconstruction methods such as Filtered Back Projection, FFT-based algorithms, ART (Algebraic Reconstruction Technique), SART (Simultaneous Algebraic Reconstruction Technique), etc. Alternatively, the attenuation pattern may be generated by adapting one or more basis functions or by statistical methods such as Bayesian inversion. Examples of such reconstruction functions designed for use in touch determination arc found in WO2009/077962, WO2011/049511, WO2011/139213, WO2012/050510 and US2014/0300572, all of which are incorporated herein by reference in their entireties. Conventional image reconstruction techniques are found in the mathematical literature, e.g., “The Mathematics of Computerized Tomography” by Natterer, and “Principles of Computerized Tomographic Imaging” by Kak and Slaney.

In the illustrated example, the apparatus 600 can also include a controller 12 which can be connected to selectively control the activation of the emitters 2 and, possibly, the readout of data from the detectors 3. Depending on the implementation, the emitters 2 or detectors 3 may be activated in sequence or concurrently. The signal processor 10 and the controller 12 may be configured as separate units, or they may be incorporated in a single unit. One or both of the signal processor 10 and the controller 12 may be at least partially implemented by software executed by a hardware processor 14.

FIGS. 6A-6B illustrate an example touch-sensitive apparatus. For example, instead of injecting and detecting light via the edge surface that connects the boundary surfaces 5, 6, light may be coupled into or out of the panel 1 via the top or bottom surfaces 5, 6, e.g., by the use of dedicated coupling elements attached to the panel 1. It is also conceivable that the light is coupled into and out of the panel 1 through different portions of the panel, e.g., via the boundary surface 5 and the boundary surface 6, respectively. Examples of alternative FTIR-based touch systems are e.g. disclosed in U.S. Pat. No. 7,432,893, WO2010/046539, WO2012/105893 and WO2013/089622, all of which are incorporated herein by reference in their entireties.

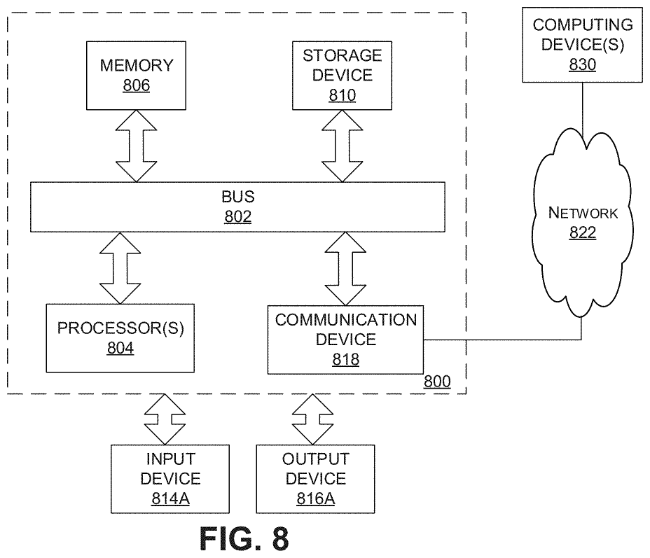

FIG. 8 depicts a general architecture of a computing system 800 (sometimes referenced herein as a user computing device, touch sensing device, server, or computing device). The computing system 800 or components of the computing system 800 may be implemented by any of the devices or components discussed herein, such as the computing device(s) 100, 102, 202, the media sharing server 206, the pointer event server 208, or the graphical user interface system 200. The general architecture of the computing system 800 depicted in FIG. 8 includes an arrangement of computer hardware and software components that may be used to implement aspects of the present disclosure. The computing system 800 may include many more (or fewer) elements than those shown in FIG. 8. It is not necessary, however, that all of these elements be shown in order to provide an enabling disclosure. As illustrated, the computing system 800 includes one or more hardware processors 804, a communication interface 818, a computer readable medium storage device 810, one or more input devices 814A (such as a touch screen, mouse, keyboard, etc.), one or more output devices 816A (such as a monitor, screen, or display), and memory 806, some of which may communicate with one another by way of a communication bus 802 or otherwise. The communication interface 818 may provide connectivity to one or more networks or computing systems. The hardware processor(s) 804 may thus receive information and instructions from other computing systems or services via the network 822.

The memory 806 may contain computer program instructions (grouped as modules or components in some embodiments) that the hardware processor(s) 804 executes in order to implement one or more embodiments. The memory 806 generally includes RAM, ROM or other persistent, auxiliary or non-transitory computer-readable media. The memory 806 may store an operating system that provides computer program instructions for use by the hardware processor(s) 804 in the general administration and operation of the computing system 800. The memory 806 may further include computer program instructions and other information for implementing aspects of the present disclosure. In addition, memory 806 may include or communicate with the storage device 810. A storage device 810, such as a magnetic disk, optical disk, or USB thumb drive (Flash drive), etc., is provided and coupled to the bus 802 for storing information, data, or instructions.

The memory 806 also may be used for storing temporary variables or other intermediate information during execution of instructions to be executed by hardware processor(s) 804. Such instructions, when stored in storage media accessible to hardware processor(s) 804, render the computer system 800 into a special-purpose machine that is customized to perform the operations specified in the instructions.

In general, the word “instructions,” as used herein, refers to logic embodied in hardware or firmware, or to a collection of software modules, possibly having entry and exit points, written in a programming language, such as, but not limited to, Java, Scala, Lua, C, C++, or C #. A software module may be compiled and linked into an executable program, installed in a dynamic link library, or may be written in an interpreted programming language such as, but not limited to, BASIC, Perl, or Python. It will be appreciated that software modules may be callable from other modules or from themselves, or may be invoked in response to detected events or interrupts. Software modules configured for execution on computing devices by their hardware processor(s) may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, or may be comprised of programmable units, such as programmable gate arrays or processors. The modules or computing device functionality described herein are preferably implemented as software modules, but may be represented in hardware or firmware. Generally, the instructions described herein refer to logical modules that may be combined with other modules or divided into sub-modules despite their physical organization or storage.

The term “non-transitory media,” and similar terms, as used herein refers to any media that store data or instructions that cause a machine to operate in a specific fashion. Such non-transitory media may comprise non-volatile media or volatile media. Non-volatile media includes, for example, optical or magnetic disks, such as the storage device 810. Volatile media includes dynamic memory, such as the main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise the bus 802. Transmission media can also take the form of acoustic or light waves, such as those generated during radio-wave and infra-red data communications.

Computing system 800 also includes a communication interface 818 coupled to the bus 802. Communication interface 818 provides a two-way data communication to the network 822. For example, communication interface sends and receives electrical, electromagnetic, or optical signals that carry digital data streams representing various types of information via cellular, packet radio, GSM, GPRS, CDMA, WiFi, satellite, radio, RF, radio modems, ZigBee, XBee, XRF, XTend, Bluetooth, WPAN, line of sight, satellite relay, or any other wireless data link.

The computing system 800 can send messages and receive data, including program code, through the network 822 and the communication interface 818. A computing system 800 may communicate with other computing devices 830 via the network 822.

The computing system 800 may include a distributed computing environment including several computer systems that are interconnected using one or more computer networks. The computing system 800 could also operate within a computing environment having a fewer or greater number of devices than are illustrated in FIG. 8.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A hardware processor can include electrical circuitry or digital logic circuitry configured to process computer-executable instructions. In another embodiment, a processor includes an FPGA, other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a device controller, or a computational engine within an appliance, to name a few.

The steps of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements or states. Thus, such conditional language is not generally intended to imply that features, elements or states are in any way required for one or more embodiments or that one or more embodiments necessarily include logic for deciding, with or without author input or prompting, whether these features, elements or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others.

What is claimed is:

1. A system comprising:
a media sharing server comprising one or more first hardware processors configured to execute first computer-readable instructions to:
receive media from a media sharing computing device; and
cause presentation, on a user computing device, of the media as a media presentation; and
a pointer event server comprising one or more second hardware processors configured to execute second computer-readable instructions to:
receive, from a multi-touch sensing computing device, a first set of touch user inputs for a first pointer;
cause presentation, on the media presentation of the user computing device, of a first annotation visualization corresponding to the first set of touch user inputs;
receive, from the multi-touch sensing computing device, a first event that indicates that the first pointer is released;
initiate a first fadeout timer based at least in part on the first event that indicates that the first pointer is released;
before the first fadeout timer expires, receive, from the multi-touch sensing computing device, a second set of touch user inputs for a second pointer;
cause presentation, on the media presentation of the user computing device, of a second annotation visualization corresponding to the second set of touch user inputs;
receive, from the multi-touch sensing computing device, a second event that the second pointer is released;
initiate a second fadeout timer that replaces the first fadeout timer, wherein initiation of the second fadeout timer is based at least in part on the second event that indicates that the second pointer is released;
determine that the second fadeout timer expired; and
cause presentation, on the media presentation of the user computing device, of a nearly simultaneous fadeout of the first annotation visualization and the second annotation visualization.

2. The system of claim 1, wherein the media sharing computing device and the multi-touch sensing computing device are the same device.

3. The system of claim 1, wherein the user computing device and the multi-touch sensing computing device are the same device.

4. The system of claim 1, wherein the media sharing server and the media sharing computing device are the same device.

5. The system of claim 1, wherein the one or more second hardware processors are further configured to:
receive, from the multi-touch sensing computing device, a third set of touch user inputs; and
cause presentation, on the media presentation of the user computing device, of a third annotation visualization corresponding to the third set of touch user inputs.

6. The system of claim 5, wherein the one or more second hardware processors are further configured to:
determine, from the third set of touch user inputs, a subset of touch user inputs that occur within a threshold period of time and within a threshold area;
determine, using an exponential equation, a fadeout time period based at least in part on the subset of touch user inputs; and
cause presentation, on the media presentation of the user computing device, of a fadeout of the third annotation visualization according to the fadeout time period.

7. The system of claim 5, wherein the one or more second hardware processors are further configured to:
identify that the third set of touch user inputs are located within a persistence area; and
mark the third annotation visualization as a persistent visualization.

8. The system of claim 1, wherein the one or more second hardware processors are further configured to:
store, in a non-transitory computer storage medium, a plurality of pointer events, wherein each pointer event from the plurality of pointer events corresponds to a touch user input from the first set of touch user inputs, and wherein each pointer event from the plurality of pointer events comprises a timestamp;
receive, from a second user computing device, a playback request; and
cause presentation, on a second media presentation of the second user computing device, of a fourth annotation visualization according to each timestamp and pointer event from the plurality of pointer events.

9. A system comprising:
a non-transitory computer storage medium configured to at least store computer-readable instructions; and
one or more hardware processors in communication with the non-transitory computer storage medium, the one or more hardware processors configured to execute the computer-readable instructions to at least:
receive a first set of user inputs for a first pointer;
cause presentation, on a user computing device, of media as a media presentation;
cause presentation, on the media presentation of the user computing device, of a first annotation visualization corresponding to the first set of user inputs;
receive a first event that indicates that the first pointer is released;
initiate a first fadeout timer based at least in part on the first event that indicates that the first pointer is released;
before the first fadeout timer expires, receive a second set of user inputs for a second pointer;
cause presentation, on the media presentation of the user computing device, of a second annotation visualization corresponding to the second set of user inputs;
receive a second event that the second pointer is released;
initiate a second fadeout timer that replaces the first fadeout timer, wherein initiation of the second fadeout timer is based at least in part on the second event that indicates that the second pointer is released;
determine that the second fadeout timer expired; and
cause presentation, on the media presentation of the user computing device, of a first fadeout of the first annotation visualization and a second fadeout of the second annotation visualization.

10. The system of claim 9, wherein the first annotation visualization comprises a first animation.

11. The system of claim 10, wherein presentation of a first frame of the first animation comprises a first point and a second point, wherein presentation of the first point is thicker than presentation of the second point, and wherein the first point comprises a first contrast and the second point comprises a second contrast.

12. The system of claim 10, wherein the first fadeout of the first annotation visualization begins at a starting point of the first animation and ends at an ending point of the first animation.

13. The system of claim 9, wherein the first set of user inputs corresponds to touch user inputs or mouse user inputs.

14. The system of claim 9, wherein the one or more hardware processors are further configured to:
receive a third set of user inputs;
cause presentation, on the media presentation of the user computing device, of a third annotation visualization corresponding to the third set of touch user inputs;
identify that the third set of user inputs are located within a persistence area; and
mark the third annotation visualization as a persistent visualization.

15. The system of claim 9, wherein the user computing device comprises an interactive touch monitor.

16. A computer-implemented method comprising:
receiving a first set of user inputs for a first pointer;
causing presentation of media as a media presentation;
causing presentation, on the media presentation, of a first annotation visualization corresponding to the first set of user inputs;
receiving a first event that indicates that the first pointer is released;
initiating a first fadeout timer based at least in part on the first event that indicates that the first pointer is released;
before the first fadeout timer expires, receiving a second set of user inputs for a second pointer;
causing presentation, on the media presentation, of a second annotation visualization corresponding to the second set of user inputs;
receiving a second event that the second pointer is released;
initiating a second fadeout timer that replaces the first fadeout timer, wherein initiating the second fadeout timer is based at least in part on the second event that indicates that the second pointer is released;
determining that the second fadeout timer expired; and
causing presentation, on the media presentation, of a first fadeout of the first annotation visualization and a second fadeout of the second annotation visualization.

17. The computer-implemented method of claim 16, wherein the first annotation visualization comprises a first animation, wherein presentation of a first frame of the first animation comprises a first point and a second point, wherein presentation of the first point is thicker than presentation of the second point.

18. The computer-implemented method of claim 16, wherein the first annotation visualization comprises a first animation, wherein the first fadeout of the first annotation visualization begins at a starting point of the first animation and ends at an ending point of the first animation.

19. The computer-implemented method of claim 16, further comprising:
receiving a third set of touch user inputs;
causing presentation, on the media presentation, of a third annotation visualization corresponding to the third set of user inputs;
identifying that the third set of user inputs are located within a persistence area; and
marking the third annotation visualization as a persistent visualization.

20. The computer-implemented method of claim 16, wherein the first fadeout of the first annotation visualization occurs without a direct user command for with the first fadeout.
